(19) United States
(12) Patent Application Publication
(10) Pub. No.: US 2026/0187806 A1
(43) Pub. Date: Jul. 2, 2026

(54) METHOD, APPARATUS, DEVICE, MEDIUM AND PROGRAM PRODUCT FOR CROPPING IMAGES

(71) Applicant: Beijing Zitiao Network Technology Co., Ltd., Beijing (CN)

(72) Inventor: Tianya YI, Beijing (CN)

(21) Appl. No.: 19/427,811

(22) Filed: Dec. 19, 2025

(30) Foreign Application Priority Data
Jan. 2, 2025 (WO) PCT/CN2025/070152

(51) Int. Cl. G06T 7/10; G06T 3/60

(52) U.S. Cl. CPC G06T 7/10; G06T 3/60; G06T 2207/20132

(57) ABSTRACT

The present disclosure relates to a method, apparatus, a device, a medium and a program product for cropping images. The method comprises displaying an image in a plurality of images to be cropped and a set of cropping ratios for the plurality of images. The method also comprises in response to receiving a selection for a cropping ratio in the set of cropping ratios, displaying the cropped image. The method further comprises in response to the cropped image being displayed, displaying a control for applying the cropping ratio to the plurality of images on the cropped image. The method also comprises in response to receiving an operation for the control, applying the cropping ratio to the plurality of images. According to this method, after one of a plurality of images is cropped, a control is displayed on the cropped image and the “one-click cropping” is fulfilled using the control.

### CROSS-REFERENCE TO RELATED APPLICATION(S)

This application claims priority to PCT Application No. PCT/CN2025/070152 filed Jan. 2, 2025, the disclosure of which is incorporated herein by reference in its entity.

### FIELD

Embodiments of the present disclosure generally relate to the field of image processing, and more specifically, to a method, an apparatus, a device, a medium and a program product for cropping images.

### BACKGROUND

At present, for image-making, it is usually required to adjust one image separately, such as to perform image ratio cropping, image rotation, image mirroring and image horizontal adjustment on an image. After these, the adjusted image is saved and a further image is subject to corresponding adjustment operations, which may reduce the image processing efficiency. It is a huge challenge for the work that needs a large amount of images to be processed.

With the development of image processing technology, the efficiency for processing images in batch also increases. For example, while processing a large amount of images, technicians have developed a one-click image processing function to rapidly process a plurality of images. The image processing efficiency is boosted by using the functions such as the one-click image processing.

### SUMMARY

Embodiments of the present disclosure provide a method, an apparatus, a device, a medium and a program product for cropping images.

In accordance with a first aspect of the present disclosure, there is provided a method for cropping images. The method comprises displaying an image in a plurality of images to be cropped and a set of cropping ratios for the plurality of images. The method also comprises in response to receiving a selection for a cropping ratio in the set of cropping ratios, displaying the cropped image. The method further comprises in response to the cropped image being displayed, displaying a control for applying the cropping ratio to the plurality of images on the cropped image. The method also comprises in response to receiving an operation for the control, applying the cropping ratio to the plurality of images.

In accordance with a second aspect of the present disclosure, there is provided an apparatus for cropping images. The apparatus comprises an image and cropping ratio display module configured to display an image in a plurality of images to be cropped and a set of cropping ratios for the plurality of images; a cropped image display module configured to, in response to receiving a selection for a cropping ratio in the set of cropping ratios, display the cropped image; a control display module configured to, in response to the cropped image being displayed, display a control for applying the cropping ratio to the plurality of images on the cropped image; and a cropping ratio application module configured to, in response to receiving an operation for the control, apply the cropping ratio to the plurality of images.

In accordance with a third aspect of the present disclosure, there is provided an electronic device, comprising at least one processor; and a memory for storing at least one program, the at least one program, when executed by the at least one processor, causing the at least one processor to implement the method according to the first aspect of the present disclosure.

In accordance with a fourth aspect of the present disclosure, there is provided a computer-readable storage medium stored thereon with computer programs, the computer programs, when executed by a processor, implementing the method according to the first aspect of the present disclosure.

In accordance with a fifth aspect of the present disclosure, there is provided a computer program product. The computer program product includes computer programs, the computer programs, when executed by a processor, implement the method according to the first aspect of the present disclosure.

It should be appreciated that the contents described in this content section are not intended to define key or essential features of the embodiments of the present disclosure, or limit the scope of the present disclosure. Other features of the present disclosure will be understood more easily through the following description.

### BRIEF DESCRIPTION OF THE DRAWINGS

Through the following more detailed description of the example embodiments of the present disclosure with reference to the accompanying drawings, the above and other objectives, features, and advantages of the present disclosure will become more apparent. In the example embodiments of the present disclosure, the same reference sign usually indicates the same component.

FIG. 1 illustrates a schematic diagram of an example environment in which the device and/or method according to some embodiments of the present disclosure may be implemented;

FIG. 2 illustrates a schematic diagram of an example method for cropping images according to some embodiments of the present disclosure;

FIG. 3 illustrates a schematic diagram of an example of a cropping interface for cropping images according to some embodiments of the present disclosure

FIG. 4 illustrates a schematic diagram of an example for selecting cropping ratios according to some embodiments of the present disclosure;

FIG. 5 illustrates a schematic diagram of an example of the cropping interface after the control is operated according to some embodiments of the present disclosure;

FIG. 6 illustrates a schematic diagram of an example of angle adjustment for cropping images according to some embodiments of the present disclosure;

FIG. 7 illustrates a schematic block diagram of a further example of angle adjustment for cropping images according to some embodiments of the present disclosure;

FIG. 8 illustrates a schematic diagram of an example of mirror function for cropping images according to some embodiments of the present disclosure;

FIG. 9 illustrates a schematic diagram of an example of drag and cropping function for cropping images according to some embodiments of the present disclosure;

FIG. 10 illustrates a schematic diagram of an example of rotation function for cropping images according to some embodiments of the present disclosure;

FIG. 11 illustrates a schematic block diagram of an apparatus for cropping images according to some embodiments of the present disclosure;

FIG. 12 illustrates a schematic block diagram of an example device adapted to implement a plurality of embodiments of the present disclosure.

In each drawing, same or corresponding reference sign indicates the same or corresponding component.

### DETAILED DESCRIPTION OF EMBODIMENTS

It is to be understood that data involved in the technical solutions of the present disclosure, including but not limited to data per se, and acquisition or use of the data, should follow requirements of corresponding laws, regulations and rules.

It is to be appreciated that prior to the use of the technical solutions disclosed by various embodiments of the present disclosure, type, usage scope and application scenario of personal information involved in the present disclosure are made known to users through suitable ways in accordance with the relevant laws and regulations, to obtain user authorization.

For example, in response to receiving an active request from the users, a prompt message is sent to the users to clearly inform them that the operation requested to be executed needs to obtain and use their personal information. Accordingly, the users may voluntarily select, in accordance with the prompt message, whether to provide their personal information to software or hardware that performs operations of the technical solution, such as electronic device, application program, server or storage medium.

As an optional and non-restrictive implementation, in response to receiving an active request from the users, a prompt message is sent to the users, wherein the prompt message may be present in the form of pop-up window as an example and the prompt message may be displayed in text in the pop-up window. Besides, the pop-up window may also carry a select control through which the users may choose to “agree” or “disagree” the provision of personal information to the electronic device.

It should be appreciated that the above procedure for informing the users and obtaining the user authorization is only exemplary and does not restrict the implementations of the present disclosure. Other methods may also be applied to the implementations of the present disclosure as long as they comply with relevant regulations and laws.

Embodiments of the present disclosure will be described below in more details with reference to the drawings. Although the drawings illustrate some embodiments of the present disclosure, it should be appreciated that the present disclosure can be implemented in various manners and should not be limited to the embodiments explained herein. On the contrary, the embodiments are provided for a more thorough and complete understanding of the present disclosure. It is to be understood that the drawings and the embodiments of the present disclosure are provided merely for the exemplary purpose, rather than restricting the protection scope of the present disclosure.

In the description of the embodiments of the present disclosure, the term “includes” and its variants are to be read as open-ended terms that mean “includes, but is not limited to.” The term “based on” is to be read as “based at least in part on.” The term “one embodiment” or “this embodiment” is to be read as “at least one embodiment.” The terms “first”, “second” and so on can refer to same or different objects. The following text also may include other explicit and implicit definitions.

Many problems are still to be solved in image cropping. For example, when images are processed in batch on a computing device (e.g., computer or smart phone etc.), it is required to crop a large amount of images, so as to crop the original images into an appropriate image ratio and generate new images. However, when the cropping is usually performed, it needs to be operated on an operation interface of the computing device. For example, when users need to crop loads of images, they will use the “one-click cropping” function in the operation interface of the computing device. It is first required to zoom, crop and rotate one image. After the processed image is determined, attributes (such as image ratio, image size and image rotating direction etc.) of the processed image may be directly applied to all of the other images through the “one-click cropping” function.

However, in such case, it is required to preset an interactive button for implementing the “one-click cropping” on the image processing interface. However, this button will occupy a certain interface space, which may reduce utility rate of space of the operation interface for image cropping. Besides, the above interactive button usually is not fixed and may affect the user experience in image processing.

To at least solve the above and other potential problems, embodiments of the present disclosure provide a method for cropping images. In this method, images in a plurality of images to be cropped and a set of cropping ratios for a plurality of images may be displayed at the computing device first. Next, the computing device also may crop the images and display the cropped images after receiving a selection for one cropping ratio in the set of cropping ratios. Afterwards, the computing device displays a control for applying the cropping ratio to a plurality of images on the cropped image. In the end, after receiving an operation for the control, the computing device applies the cropping ratio to a plurality of images. According to this method, after one of a plurality of images is cropped, a control is displayed on the cropped image and the “one-click cropping” is fulfilled using the control. Accordingly, not only is the utility rate of the interface space improved, but also a more obvious operation mode of the control is provided, and further, the efficiency for cropping a plurality of images is enhanced and the user experience is improved.

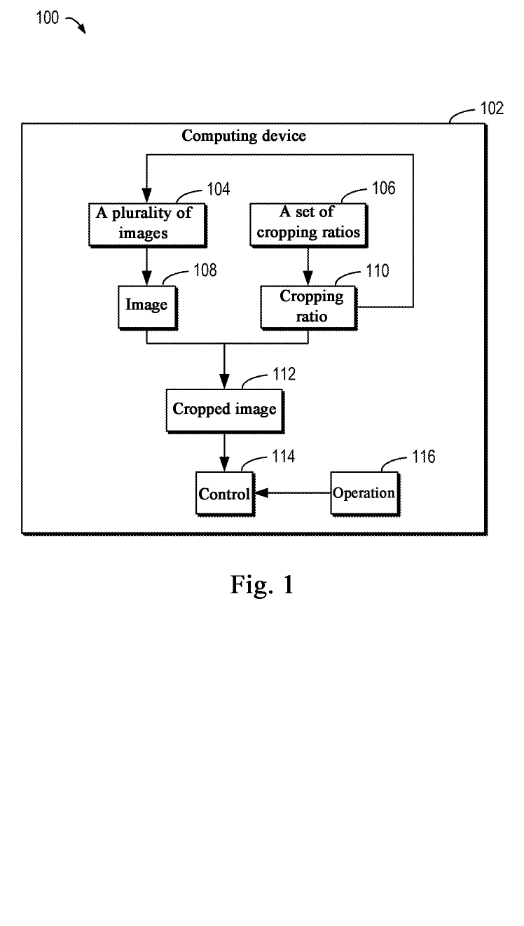

Embodiments of the present disclosure are to be described in details below with reference to the drawings, wherein FIG. 1 illustrates an example environment in which the device and/or method of the embodiments of the present disclosure may be implemented. In the environment 100, the computing device 102 first displays an image 108 in a plurality of images 104 and a set of cropping ratios 106 for a plurality of images 104. For example, a plurality of images 104 are displayed in order. Next, the computing device 102 crops the image 108 after receiving a selection for a cropping ratio 110 in the set of cropping ratios 106 and then displays a cropped image 112. Afterwards, the computing device 102 displays a control 114 for applying the cropping ratio 110 to a plurality of images on the cropped image 112. In the end, the computing device 102 applies the cropping ratio 110 to a plurality of images 104 after receiving an operation 116 for the control 114, such as clicking operation.

Examples of the computing device 102 include, but not limited to, personal computer, server computer, hand-held or laptop device, mobile device (e.g., mobile phone, Personal Digital Assistant (PDA), and media player etc.), multi-processor system, consumer electronic, minicomputer, large-scale computer, and a distributed computing environment including any of the above systems or devices.

As shown in FIG. 1, when performing a cropping processing on images, the computing device 102 needs to obtain a plurality of images 104 to be cropped. For example, the computing device 102 may receive a plurality of images uploaded by users or the computing device 102 receives a plurality of images from a network or other computing devices. In one example, at the beginning of the processing of a plurality of images 104, a first image in a plurality of images 104 may be displayed at the image processing interface (e.g., image cropping interface).

Further, a set of cropping ratios 106 also exist in the interface for cropping images in the computing device 102. In one example, the set of cropping ratios are preset. For example, the cropping ratio is 3:4 or 9:16 etc. In another example, the set of cropping ratios may be set by users. For example, the users may set the cropping ratio via a cropping ratio setting interface. The users may set the cropping ratio by inputting an aspect ratio of an image to be cropped in the cropping ratio setting interface. In a further example, the cropping ratio is represented by width and height of the image. For example, the image in the cropping ratio has a height of 10 cm and a width of 6 cm. The above examples are provided merely for describing the present disclosure, rather than restricting it.

When users select one cropping ratio 110 from the set of cropping ratios 116 through the cropping interface, the image 108 is cropped according to the selected cropping ratio 110. For example, when the users select a ratio of 3:4, the computing device 102 crops the image 108 by the ratio of 3:4. Then, the computing device displays the cropped image 112 on the cropping interface.

After the cropped image 112 is displayed, the computing device 102 displays a control 114 for applying the cropping ratio 110 to a plurality of images on the cropped image 112. Additionally, a text prompt for applying the selected cropping ratio to a plurality of images may also be displayed on the control 114, such as “applying the ratio to all images”.

In the end, after receiving an operation 116 for the control 114, the computing device 102 applies the cropping ratio 110 to a plurality of images 104. For example, the control 114 may receive an operation of clicking for the control or an operation of long pressing for the control to apply the cropping ratio 110 to a plurality of images 104.

Additionally, after receiving the operation for the control 114, the computing device may stop displaying the control 114 and display a text prompt that the cropping ratio 110 has been applied to a plurality of images 104 on a cropping interface.

In some embodiments, the text prompt indicating that the cropping ratio 110 has been applied to a plurality of images 104 will not stop being displayed until the computing device receives an operation of selecting other images in the image queue. Upon receiving an operation for saving a plurality of images, the computing device saves a plurality of images 104 to which a first cropping ratio is applied.

According to this method, after one of a plurality of images is cropped, a control is displayed on the cropped image and the “one-click cropping” is fulfilled using the control. Accordingly, not only is the utility rate of the interface space improved, but also a more obvious operation mode of the control is provided, and further, the efficiency for cropping a plurality of images is enhanced and the user experience is improved.

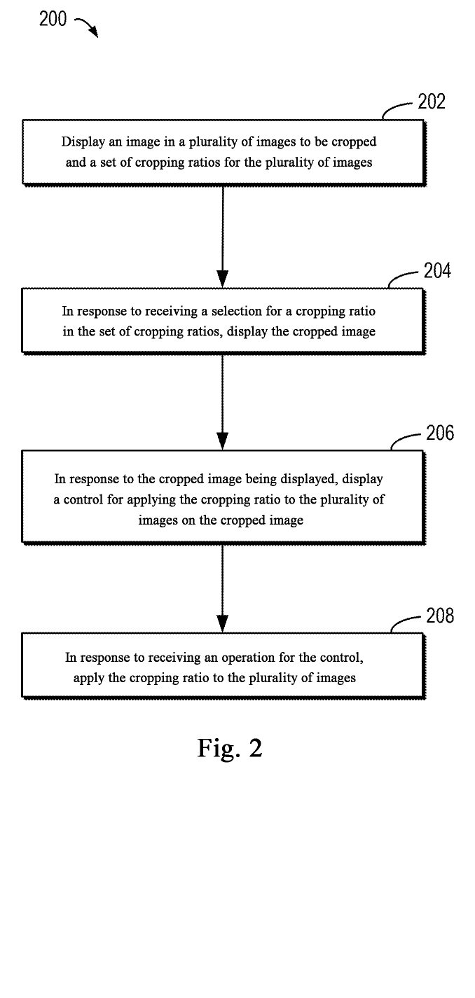

The schematic diagram of an example environment in which the device and/or method according to some embodiments of the present disclosure may be implemented has been described above with reference to FIG. 1. Next, a schematic diagram of an example method for cropping images according to some embodiments of the present disclosure is to be depicted below with reference to FIG. 2. The method in FIG. 2 may be executed by the computing device 102 in FIG. 1 and/or any suitable computing devices.

As shown in FIG. 2, in the example method 200, at block 202, the computing device 102 displays the image 108 in the plurality of images 104 to be cropped and a set of cropping ratios 106 for a plurality of images 104.

In some embodiments, a plurality of images 104 constitutes an image queue, and thumbnails of the images in the image queue are also displayed on the cropping interface of the computing device. For example, one image to be processed in the plurality of images is displayed on the cropping interface, and thumbnails of the images in the image queue also may be displayed at any suitable positions, such as above, below, to the left or to the right of the image.

For example, if there is a small amount of images, the thumbnails of all images may be placed on the cropping interface; if there are loads of images, thumbnails of a predetermined number of images in the plurality of images are selected to be displayed on the cropping interface. For example, in a mobile phone terminal, due to its small screen, thumbnails of up to 3 images may be displayed. In addition, when users perform a predetermined operation, thumbnails not displayed on the cropping interface may be displayed on the cropping interface. For instance, all thumbnails may be displayed when being viewed by the users. Additionally, a thumbnail of an image being processed in the cropping interface may be displayed at the middle position of the horizontal position of the thumbnail. For example, at the beginning of the processing of a plurality of images, a thumbnail of the first image may be placed at the middle position of the horizontal position of the thumbnail.

In some embodiments, when the computing device enters the cropping interface, a first image in the image queue is usually displayed on the cropping interface and the image ratio of this time is in its original ratio.

In some embodiments, the computing device 102 may display a corresponding image in the cropping interface by receiving an operation of clicking for a thumbnail in a set of thumbnails displayed. Additionally, the computing device may determine a position of the thumbnail as the middle position of the horizontal position by receiving an operation of clicking for a thumbnail at a horizontal position of the thumbnails, and display the image corresponding to the clicked thumbnail on the cropping interface of the computing device.

In some embodiments, the computing device 102 may adjust the position of the thumbnail by receiving an operation of sliding for the thumbnail in the horizontal direction, and display an image corresponding to the thumbnail at the middle position after the sliding operation stops on the cropping interface of the computing device.

In some embodiments, the horizontal position of the thumbnail is an image banner and the computing device is equipped with a gyroscope. When an operation of tilting for the computing device is received, the image banner will automatically slide for a distance and stop. At this moment, the computing device 102 may display an image corresponding to a thumbnail at the middle position of the image banner on the cropping interface of the computing device.

In some embodiments, the position of the thumbnail of the image may be in a vertical direction orthogonal to the horizontal direction. The operations on the thumbnail at the vertical position are similar to those on the thumbnail at the horizontal position.

Then, at block 204, the computing device 102 displays the cropped image 112 in response to receiving a selection for the cropping ratio 110 in the set of cropping ratios 106. In some embodiments, the cropping ratios include original ratio, arbitrary ratio, 3:4, 9:16, 1:1 and 4:3 etc.

After one cropping ratio in the set of cropping ratios is selected, the computing device applies the selected cropping ratio to the image 108 and then displays a cropped image 112 generated from the image 108 on the cropping interface.

Next, at block 206, the computing device 102 displays the control 114 for applying the cropping ratio 110 to a plurality of images on the cropped image 112 in response to the cropped image 112 being displayed. To facilitate the users to implement “one-click cropping” function for a plurality of images, the control for executing such function is displayed on the cropped image 112, which may reduce the occupancy of the interface space and increase the utility rate of the interface space. Additionally, a text prompt for applying the selected cropping ratio to a plurality of images may be displayed on the control 114.

In some embodiments, the control 114 is displayed in a designated area of the cropping interface. In one example, the control 114 is displayed at any suitable positions of the cropping image, such as upper left, lower left, upper right or upper left. Additionally, the text prompt of the control 114 is displayed in an area which occupies no more than 5% of the area of the entire cropping image at the upper left corner, lower left corner, upper right corner or lower right corner of the cropping image.

In some embodiments, the text prompt corresponding to the control 114 has a preset transparency. In one example, the text prompt corresponding to the control 114 has a preset transparency of 30%.

In some embodiments, after the control 114 is displayed, the computing device 102 also may further receive a selection for the predetermined function by the user. For example, the predetermined function includes at least one of: drag and cropping, mirror, rotation, angle adjustment. After receiving a selection for the predetermined function of the cropped image, the computing device hides the control 114. Additionally, when the selection for the predetermined function is cancelled, the control 114 is re-displayed. Alternatively, when the predetermined function is completed, the control 114 is re-displayed.

In some embodiments, after receiving a selection for the angle adjustment, the computing device hides the control 114 and the set of cropping ratios 106. Then, an angle adjustment operation is performed on the image. After the selection for the angle adjustment is cancelled or after the angle adjustment is completed, the control 114 and the set of cropping ratios 106 are re-displayed.

In some embodiments, after receiving a selection for the drag and cropping, mirror or rotation, the computing device hides the control 114 and displays the set of cropping ratios and a set of thumbnails corresponding to the image queue. Alternatively, after receiving a selection for the drag and cropping, mirror or rotation, the computing device hides the control 114, remains to display the set of cropping ratios and hides the set of thumbnails corresponding to the image queue.

In the end, at block 208, in response to receiving an operation 116 for the control 114, the computing device 102 applies the cropping ratio 110 to a plurality of images 104. By performing the operation 116 on the control 114, the cropping operations executed for the image 108 may be applied to all images, so as to implement the “one-click cropping” function and enhance the image processing efficiency.

In some embodiments, the control 114 may receive the operation of clicking for the control and respond to the clicking operation to fulfill the function corresponding to the text prompt of the control 114. For example, the control 114 may receive a clicking operation for it to fulfill the function of applying the cropping ratio to a plurality of images.

In some embodiments, the control 114 may receive a long press operation to implementing applying the cropping ratio to a plurality of images. For example, when the duration of the long press operation exceeds a preset duration (e.g., 1 second), the computing device will apply the cropping ratio to a plurality of images.

In some embodiments, after receiving an operation for the control 114, the computing device stops displaying the control 114, and displays the text prompt indicating that the cropping ratio 110 has been applied to a plurality of images 104 on the cropping interface.

In some embodiments, after the first cropping ratio has been applied to a plurality of images 104, the computing device also may further process another image in a plurality of images 104 to which has been applied the first cropping ratio. For example, the user also may select a further image in a plurality of images and apply a second cropping ratio in the set of cropping ratios 106 to this image. After the image is correspondingly cropped, a control for applying the second cropping ratio to all images will be generated. If an operation is performed on the control, the second cropping ratio is re-applied to a plurality of images 104. Upon receiving an operation for saving a plurality of images, the computing device saves a plurality of images 104 to which the second cropping ratio is applied.

In addition, if an operation for the control for applying the second cropping ratio is not received, the computing device, after receiving an operation for saving a plurality of images, saves the further image corresponding to the second cropping ratio and other images corresponding to the first cropping ratio in a plurality of images 104 apart from the further image.

According to this method, after one of a plurality of images is cropped, a control is displayed on the cropped image and the “one-click cropping” is fulfilled using the control. Accordingly, not only is the utility rate of the interface space improved, but also a more obvious operation mode of the control is provided, and further the efficiency for cropping a plurality of images is enhanced and the user experience is improved.

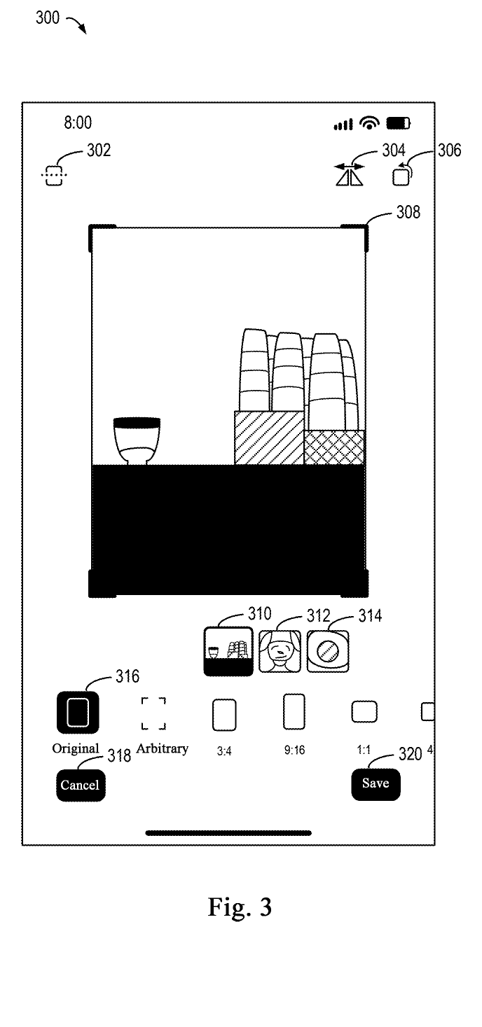

The schematic diagram of an example method for cropping images in accordance with some embodiments of the present disclosure has been described above with reference to FIG. 2. Next, a schematic diagram of an example of the cropping interface for cropping images in accordance with some embodiments of the present disclosure is to be depicted in conjunction with FIG. 3. The example of FIG. 3 may be executed by the computing device 102 shown in FIG. 1 or any suitable devices.

In the example 300 shown in FIG. 3, taking the computing device 102 as an example of the mobile phone, the cropping interface includes predetermined functions: angle adjustment function 302, mirror function 304, rotation function 306 and drag and cropping function indicated by block 308.

The cropping interface also includes a set of thumbnails for the image queue of a plurality of images, wherein the set of thumbnails also include a thumbnail 310, a thumbnail 312 and a thumbnail 314.

In some embodiments, the computing device may determine the position of other images as the middle position of the horizontal position by receiving an operation of clicking for other thumbnails at the horizontal position of the thumbnail and display an image corresponding to the clicked thumbnail on the cropping interface of the computing device. For example, after receiving the click on the thumbnail 312, the computing device will scroll the thumbnail 312 to the position of the thumbnail 310 and the thumbnails 310 and 314 will synchronously scroll to the left. Afterwards, the image corresponding to the thumbnail 312 is displayed in the block 308.

In some embodiments, the computing device may determine the position of other images as the middle position of the horizontal position by receiving a sliding operation for the horizontal position of the thumbnail, and display an image corresponding to the thumbnail at the middle position after the sliding operation stops on the cropping interface of the computing device. For example, after receiving a sliding operation for the horizontal position of the thumbnail 310, the computing device slides the thumbnail 314 to the position of the thumbnail 310 and then displays the image corresponding to the thumbnail 314 in the block 308.

The cropping interface also includes a set of cropping ratios, wherein the set of cropping ratios include original ratio 316, arbitrary ratio, 3:4, 9:16, 1:1 and 4:3.

The cropping interface also includes a cancel control 318 and a save control 320. In some embodiments, after the cropping of the image is completed, the computing device rolls back all cropping operations to an initial state after receiving an operation of clicking for the cancel control 318. In some embodiments, after the cropping of the image is completed, the computing device saves all cropping operations after receiving an operation of clicking for the save control 320.

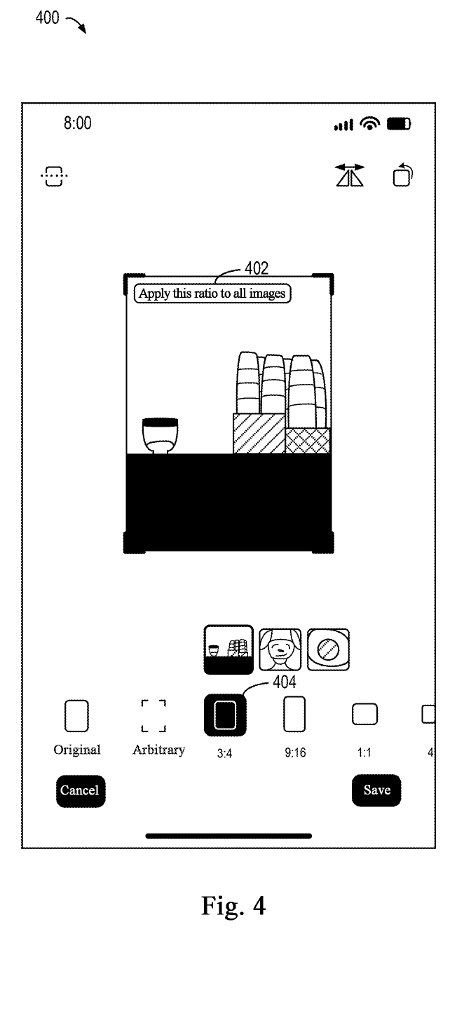

The schematic diagram of an example of the cropping interface for cropping images in accordance with some embodiments of the present disclosure has been described above with reference to FIG. 3. Next, a schematic diagram of an example for selecting a cropping ratio in accordance with some embodiments of the present disclosure is to be depicted in conjunction with FIG. 4.

In the example 400, with reference to the above example 300, after receiving an operation of selecting for a ratio 404 of 3:4, the computing device automatically adjusts the ratio of block 308 to 3:4 and displays in the block 308 and a control 402 is provided with a text prompt indicating “applying this ratio to all images”.

In this example, the text prompt corresponding to the control 402 is displayed at the upper left of the cropping interface. Additionally, the text prompt corresponding to the control 402 is displayed in an area which occupies no more than 5% of the area of the entire cropping interface at the upper left corner of the cropping interface.

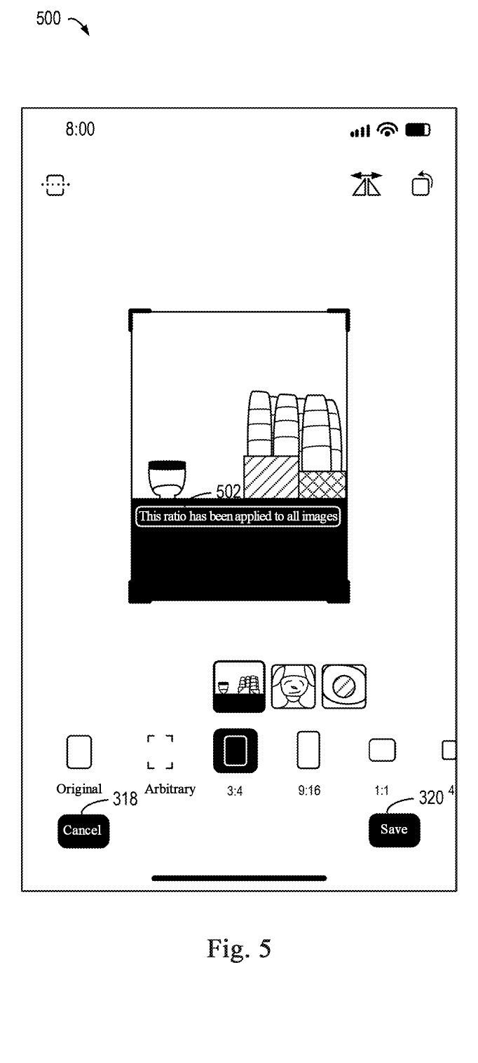

The schematic diagram of an example for selecting a cropping ratio in accordance with some embodiments of the present disclosure has been described above with reference to FIG. 4. Next, a schematic diagram of an example of the cropping interface after the control is operated in accordance with some embodiments of the present disclosure is to be depicted in conjunction with FIG. 5.

In the example 500, on the basis of the previous example 400, after the computing device receives an operation (i.e., first operation) for the control 402, a cropping ratio 404 is applied to a plurality of images and a corresponding text prompt 502 is displayed on the cropping interface, a text content of the text prompt 502 is “the ratio has been applied to all images”.

In some embodiments, the text prompt that the cropping ratio has been applied to a plurality of images will be displayed for a predetermined duration (e.g., displayed on the cropping interface for 2 seconds) and then stops being displayed.

In some embodiments, the text prompt that the cropping ratio has been applied to a plurality of images will not stop being displayed until the computing device receives an operation of selection for other images in the image queue.

After receiving an operation for the cancel control 318, the computing device rolls back the ratio of the image to the original ratio. After receiving an operation for the save control 320, the computing device saves all of the plurality of images as the first cropping ratio.

When the saving operation is not received yet, if the computing device has received a selection for a further thumbnail, displays a further image corresponding to the further thumbnail on the cropping interface. The computing device may receive a selection for other cropping ratios in the set of cropping ratios, e.g., a selection for a ratio of 9:16. To facilitate description, the ratio of 9:16 is referred to as the second cropping ratio.

After the second cropping ratio is applied to the further image, a further control for applying the second cropping ratio to a plurality of images may be displayed on a cropping interface of the further image. After receiving an operation for the further control, the computing device applies the second cropping ratio to a plurality of images. After receiving an operation of clicking for the save control, the computing device saves the image ratio of a plurality of images as the second cropping ratio.

If failing to receive the operation for the further control, the computing device will save the image ratio of the further image in the second cropping ratio after receiving an operation of clicking for the save control 320 and save other images apart from the further image as the first cropping ratio.

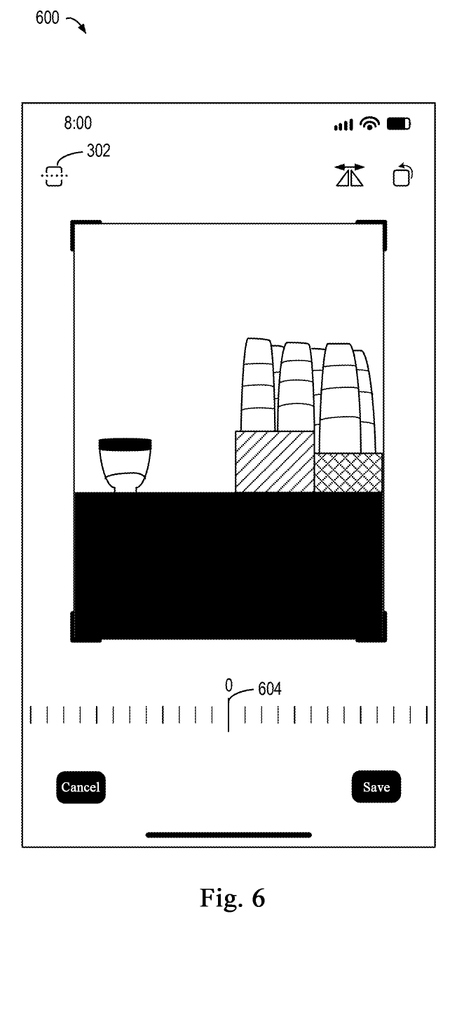

The schematic diagram of an example of the cropping interface after the control is operated in accordance with some embodiments of the present disclosure has been described above with reference to FIG. 5. Next, a schematic diagram of an example of the angle adjustment for cropping images in accordance with some embodiments of the present disclosure is to be depicted in conjunction with FIG. 6.

In the example 600, on the basis of the previous examples 300 and 400, after receiving a selection for the angle adjustment 302 in the predetermined functions, the computing device will hide the control 402, and at the same time, hide a set of thumbnails 310, 312 and 314, and at the same time, hide a set of cropping ratios in which the original ratio 316 is located.

After the control 402, the set of thumbnails and the set of cropping ratios are hidden, a slider 604 for angle adjustment is displayed below the image and the initial angle is 0 degree.

In some embodiments, the computing device may receive an operation of sliding for the slider 604 to adjust the angle of the image. Additionally, the slider for angle adjustment has a preset angle range, for example, the preset angle range is from -60 degrees to 60 degrees, namely from 60 degrees counterclockwise to 60 degrees clockwise.

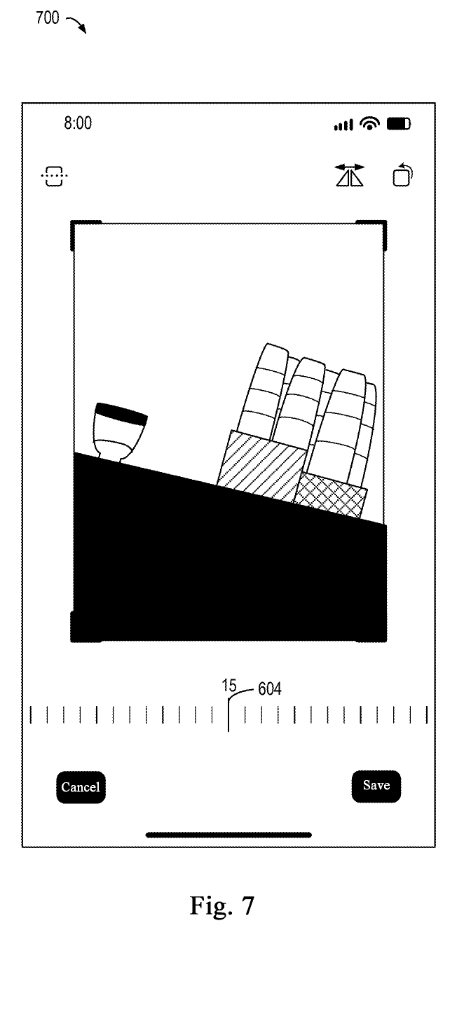

The schematic diagram of an example of the angle adjustment for cropping images in accordance with some embodiments of the present disclosure has been described above with reference to FIG. 6. Next, a schematic diagram of another example of the angle adjustment for cropping images in accordance with some embodiments of the present disclosure is to be depicted in conjunction with FIG. 7.

In the example 700, on the basis of the previous examples 400, 500 and 600, upon receiving an operation of sliding for the angle adjustment slider 604, the computing device adjusts the image by 15 degrees clockwise.

In some embodiments, the cropping interface frame remains the same after the angle adjustment and the image portion out of the cropping interface frame is not displayed. In some further embodiments, the cropping interface frame remains the same after the angle adjustment and the image portion out of the cropping interface frame is displayed in low transparency. For example, the image portion out of the cropping interface frame is displayed in a 20% transparency.

In some embodiments, after receiving an operation of clicking for the cancel control, the computing device restores the angle of the image to 0 degree and exits the angle adjustment function. At this point, the control 402, the set of thumbnails and the set of cropping ratios are re-displayed on the cropping interface.

In some embodiments, after receiving an operation of clicking for the save control, the computing device saves the angle of the image as 15 degrees and exits the angle adjustment function. At this point, the control 402, the set of thumbnails and the set of cropping ratios are re-displayed on the cropping interface.

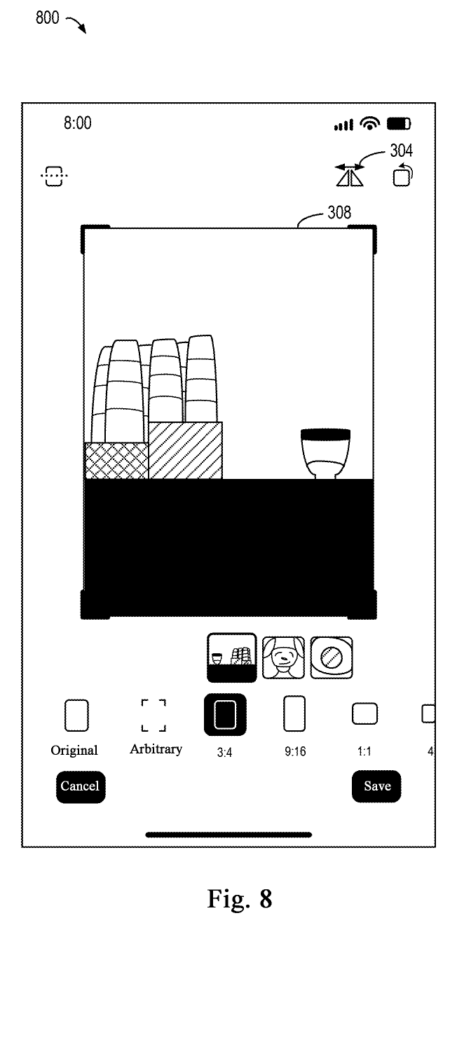

The schematic diagram of another example of the angle adjustment for cropping images in accordance with some embodiments of the present disclosure has been described above with reference to FIG. 7. Next, a schematic diagram of an example of the mirror function for cropping images in accordance with some embodiments of the present disclosure is to be depicted in conjunction with FIG. 8.

In the example 800, with reference to the previous examples 300 and 400, after a selection for the ratio of 3:4 in the set of cropping ratios is received, the mirror function 304 in the predetermined functions is selected.

In some embodiments, after receiving a selection for the mirror function 304, the computing device mirrors the image in the block 308 to obtain a mirrored image that is a mirrored image of the original image. At the same time, the control 402 is hidden. In addition, the set of thumbnails and the set of cropping ratios are not hidden.

In some embodiments, the computing device may further select left-right mirroring function or up-down mirroring function for the mirror function 304 by receiving a long-press operation for the mirror function 304. In one example, after the computing device receives a long-press operation for the mirror function 304, if the duration of the long press is shorter than a first threshold duration, the left-right mirroring is performed; if the duration of the long press is longer than or equal to the first threshold duration, the up-down mirroring is performed. In another example, further options are provided by clicking the mirror function 304 to select left-right mirroring or up-down mirroring. The control 402 may be hidden when the mirror function is operated.

In some embodiments, after receiving an operation of clicking for the cancel control, the computing device restores the mirrored image to the original image and exits the mirror function. At this point, the control 402 is re-displayed on the cropping interface.

In some embodiments, after receiving an operation of clicking for the save control, the computing device saves the mirrored image and exits the mirror function. At this point, the control 402 is re-displayed on the cropping interface.

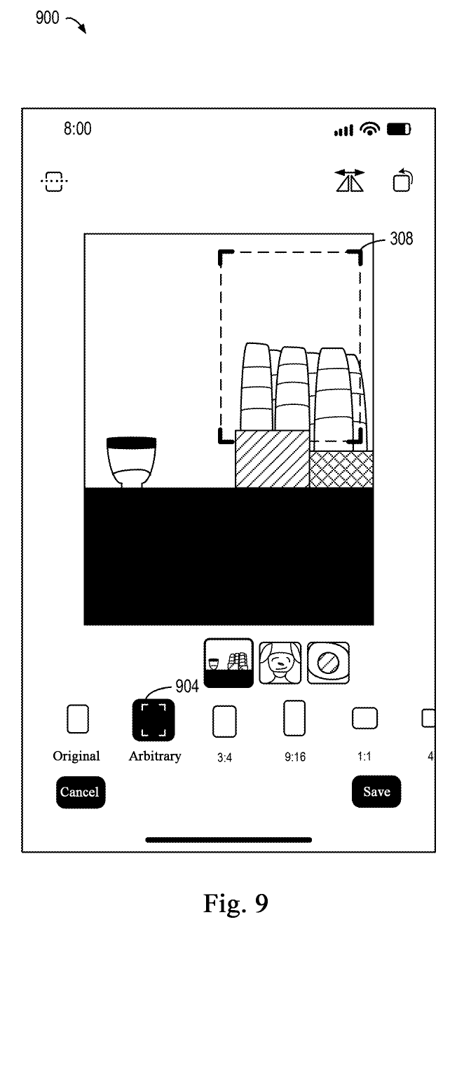

The schematic diagram of an example of the mirror function for cropping images in accordance with some embodiments of the present disclosure has been described above with reference to FIG. 8. Next, a schematic diagram of an example of the drag and cropping function for cropping images in accordance with some embodiments of the present disclosure is to be depicted in conjunction with FIG. 9.

In the example 900, with reference to the previous examples 300 and 400, after receiving a selection for an arbitrary ratio 904 in the set of cropping ratios, the computing device adjusts the ratio of the block 308 to any ratio through receiving an operation of dragging for the block 308, so as to implement the cropping operation.

In some embodiments, the area of the block 308 is above a preset ratio of the image area. In one example, the area of the block 308 is greater than or equal to 40% of the image area.

In some embodiments, after receiving an operation of clicking for the cancel control, the computing device restores the cropping interface frame to the original size and exits the drag and cropping function. At this point, the control 402 is re-displayed on the cropping interface.

In some embodiments, after receiving an operation of clicking for the save control, the computing device saves the image in the cropping interface frame and exits the drag and cropping function. At this point, the control 402 is re-displayed on the cropping interface.

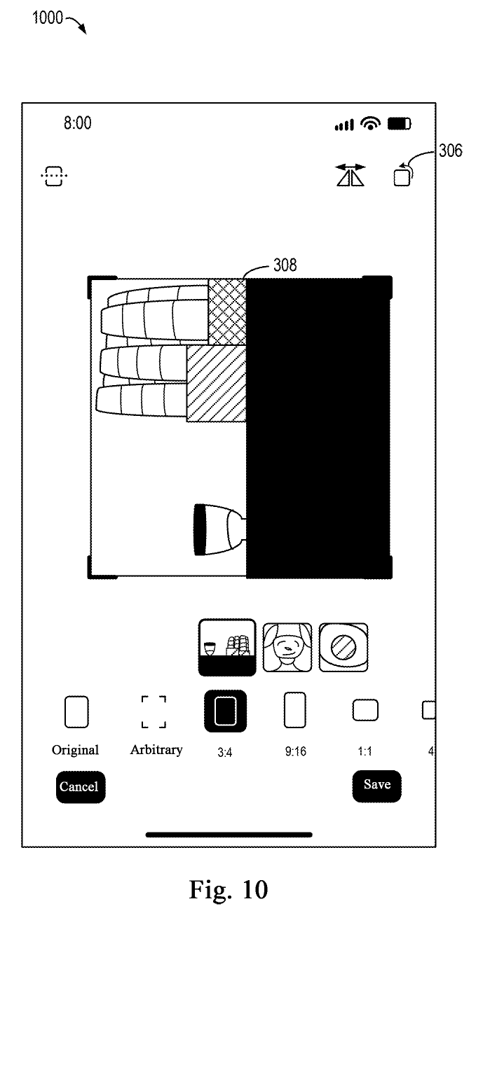

The schematic diagram of an example of the drag and cropping function for cropping images in accordance with some embodiments of the present disclosure has been described above with reference to FIG. 9. Next, a schematic diagram of an example of the rotation function for cropping images in accordance with some embodiments of the present disclosure is to be depicted in conjunction with FIG. 10.

In the example 1000, with reference to the previous examples 300 and 400, after a selection for the ratio of 3:4 in the set of cropping ratios is received, the rotation function 306 in the predetermined functions is selected.

After receiving a selection for the rotation function 306, the computing device rotates the image in the block 308 to obtain the rotated image. Meanwhile, the control 402 is hidden. In one example, the rotation function 306 is a counterclockwise rotation function. Additionally, the set of thumbnails and the set of cropping ratios are not hidden at this point.

In some embodiments, the computing device may further select a clockwise rotation function or a counterclockwise rotation function for the rotation function 306 by receiving an operation of long pressing for the rotation function 306. In one example, after receiving a long-press operation for the rotation function 306, the computing device further selects a counterclockwise function. In such case, the computing device rotates the image clockwise and hides the control 402.

In some embodiments, the rotation angle is preset. For example, the preset rotation angle is 90 degrees.

In some embodiments, after receiving an operation of clicking for the cancel control, the computing device restores the rotated image to the original image and exits the rotation function. At this point, the control 402 is re-displayed on the cropping interface.

In some embodiments, after receiving an operation of clicking for the save control, the computing device saves the rotated image and exits the rotation function. At this point, the control 402 is re-displayed on the cropping interface.

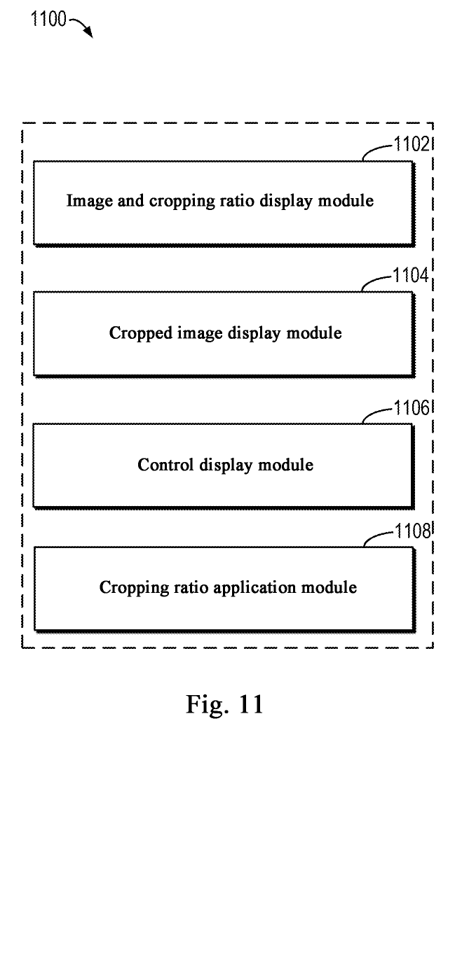

The schematic diagram of an example of the rotation function for cropping images in accordance with some embodiments of the present disclosure has been described above with reference to FIG. 10. Next, a schematic block diagram of an apparatus for cropping images in accordance with some embodiments of the present disclosure is to be depicted in conjunction with FIG. 11.

As shown in FIG. 11, the apparatus 1100 comprises an image and cropping ratio display module 1102 configured to display an image in a plurality of images to be cropped and a set of cropping ratios for the plurality of images; a cropped image display module 1104 configured to, in response to receiving a selection for a cropping ratio in the set of cropping ratios, display the cropped image; a control display module 1106 configured to, in response to the cropped image being displayed, display a control for applying the cropping ratio to the plurality of images on the cropped image; and a cropping ratio application module 1108 configured to, in response to receiving an operation for the control, apply the cropping ratio to the plurality of images.

In some embodiments, the control display module 1106 comprises: a control generating module configured to, in response to the cropped image being displayed, generate a control for applying the cropping ratio to the plurality of images; an area determining module configured to determine an area available for displaying the control in the cropped image; and a control display module configured to display the control in the area of the cropped image.

In some embodiments, the control display module comprises: a text prompt display module configured to display a text prompt for applying the cropping ratio to the plurality of images on the control.

In some embodiments, the image and cropping ratio display module 1102 comprises: a module for obtaining multiple images configured to obtain the plurality of images to be cropped; and a first image display module configured to display a first image in an image queue formed by the plurality of images.

In some embodiments, the apparatus 1100 also comprises: a control display stop module configured to, in response to applying the cropping ratio to the plurality of images, stop display of the control; and a text prompt module configured to display a text prompt that the cropping ratio has been applied to the plurality of images on the cropped image.

In some embodiments, the apparatus 1100 also comprises: a set of thumbnails display module configured to display a set of thumbnails corresponding to a set of images in the plurality of images; and a cropped image display module configured to, in response to the cropping ratio being applied to the plurality of images and a thumbnail in the set of thumbnails being selected, display a cropped image corresponding to the thumbnail.

In some embodiments, the apparatus 1100 also comprises: a selective reception determination module for a predetermined function configured to, in response to the control being displayed, determine whether a selection for a predetermined function of the cropped image is received; a control hiding module configured to, in response to receiving a selection for the predetermined function, hide the control; and a control redisplay module configured to, in response to the predetermined function being completed, re-display the control.

In some embodiments, wherein the predetermined function includes at least one of: drag and cropping, mirror, rotation and angle adjustment.

In some embodiments, wherein the predetermined function is angle adjustment and in response to receiving a selection for the predetermined function, the control hiding module comprises: in response to receiving a selection for the angle adjustment, hiding the control and the set of cropping ratios; and in response to the predetermined function being completed, the control redisplay module comprises: in response to the angle adjustment being completed, re-displaying the control and the cropping ratio.

In some embodiments, wherein the cropping ratio is a first cropping ratio, the image is a first image, and the operation is a first operation, and the apparatus 1100 also comprises: a module for determining selection of second image configured to determine that a second image in the plurality of images to which the first cropping ratio is applied is selected; a first module for applying a second cropping ratio configured to apply a second cropping ratio in the set of cropping ratios to the second image; a control display module configured to display the control for applying the second cropping ratio to the plurality of images on the second cropped image; and a second module for applying a second cropping ratio configured to, in response to receiving a second operation for the control, apply the second cropping ratio to the plurality of images.

In some embodiments, the apparatus 1100 also comprises: a module for receiving saving operation configured to, in response to not receiving the second operation for the control, receive an operation for saving the plurality of images; and a module for saving cropped second image and first image configured to, in response to receiving an operation for saving the plurality of images, save the second cropped image corresponding to the second cropping ratio and the first cropped image corresponding to the first cropping ratio.

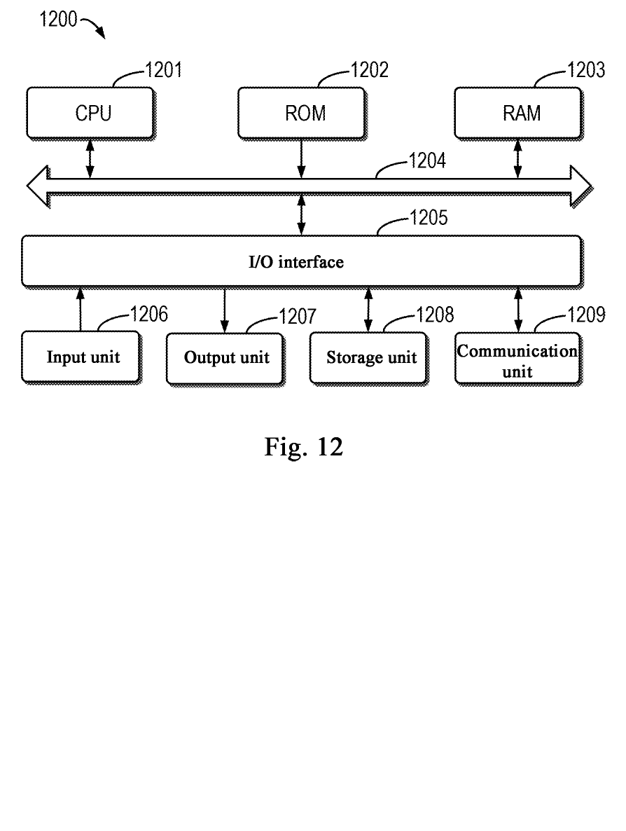

FIG. 12 illustrates a schematic block diagram of an example device 1200 for implementing embodiments of the present disclosure. The computing device 102 in FIG. 1 may be implemented by the device 1200. As shown in FIG. 12, the device 1200 comprises a central process unit (CPU) 1201, which can execute various suitable actions and processing based on the computer program instructions stored in the read-only memory (ROM) 1202 or computer program instructions loaded in the random-access memory (RAM) 1203 from the storage unit 1208. The RAM 1203 can also store all kinds of programs and data required by the operation of the device 1200. CPU 1201, ROM 1202 and RAM 1203 are connected to each other via a bus 1204. The input/output (I/O) interface 1205 is also connected to the bus 1204.

A plurality of components in the device 1200 are connected to the I/O interface 1205, comprising: an input unit 1206, such as keyboard, mouse and the like; an output unit 1207, e.g., various kinds of display and loudspeakers etc.; a storage unit 1208, such as disk and optical disk etc.; and a communication unit 1209, such as network card, modem, wireless transceiver and the like. The communication unit 1209 allows the device 1200 to exchange information/data with other devices via the computer network, such as Internet, and/or various telecommunication networks.

The above described procedure and processing, such as method 200 and examples 300-1000, can be executed by the processing unit 1201. For example, in some embodiments, method 200 and examples 300-1000 can be implemented as a computer software program tangibly included in the machine-readable medium, e.g., storage unit 1208. In some embodiments, the computer program can be partially or fully loaded and/or mounted to the apparatus 1200 via ROM 1202 and/or communication unit 1209. When the computer program is loaded to RAM 1203 and executed by the CPU 1201, one or more actions of the above described example method 200 and examples 300-1000 can be executed.

The present disclosure can be method, apparatus, system and/or computer program product. The computer program product can include a computer-readable storage medium, on which the computer-readable program instructions for executing various aspects of the present disclosure are loaded.

The computer-readable storage medium can be a tangible apparatus that maintains and stores instructions utilized by the instruction executing apparatuses. The computer-readable storage medium can be, but not limited to, such as electrical storage device, magnetic storage device, optical storage device, electromagnetic storage device, semiconductor storage device or any appropriate combinations of the above. More concrete examples of the computer-readable storage medium (non-exhaustive list) include: portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. The computer-readable storage medium utilized here is not interpreted as transient signals per se, such as radio waves or other freely propagated electromagnetic waves, electromagnetic waves propagated via waveguide or other transmission media (such as optical pulses via fiber-optic cables), or electric signals propagated via electric wires.

The described computer-readable program instruction can be downloaded from the computer-readable storage medium to each computing/processing device, or to an external computer or external storage via Internet, local area network, wide area network and/or wireless network. The network can comprise copper-transmitted cable, optical fiber transmission, wireless transmission, router, firewall, switch, network gate computer and/or edge server. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure can be assembly instructions, instructions of instruction set architecture (ISA), machine instructions, machine-related instructions, microcodes, firmware instructions, state setting data, or source codes or target codes written in any combinations of one or more programming languages, wherein the programming languages comprise object-oriented programming languages, e.g., Smalltalk, C++ and so on, and traditional procedural programming languages, such as “C” language or similar programming languages. The computer-readable program instructions can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider). In some embodiments, state information of the computer-readable program instructions is used to customize an electronic circuit, e.g., programmable logic circuit, field programmable gate array (FPGA) or programmable logic array (PLA). The electronic circuit can execute computer-readable program instructions to implement various aspects of the present disclosure.

Various aspects of the present disclosure are described here with reference to flow chart and/or block diagram of method, apparatus (system) and computer program products according to embodiments of the present disclosure. It should be understood that each block of the flow chart and/or block diagram and the combination of various blocks in the flow chart and/or block diagram can be implemented by computer-readable program instructions.

The computer-readable program instructions can be provided to the processing unit of general-purpose computer, dedicated computer or other programmable data processing apparatuses to manufacture a machine, such that the instructions that, when executed by the processing unit of the computer or other programmable data processing apparatuses, generate an apparatus for implementing functions/actions stipulated in one or more blocks in the flow chart and/or block diagram. The computer-readable program instructions can also be stored in the computer-readable storage medium and cause the computer, programmable data processing apparatus and/or other devices to work in a particular manner, such that the computer-readable medium stored with instructions comprises an article of manufacture, including instructions for implementing various aspects of the functions/actions stipulated in one or more blocks of the flow chart and/or block diagram.

The computer-readable program instructions can also be loaded into computer, other programmable data processing apparatuses or other devices, so as to execute a series of operation steps on the computer, other programmable data processing apparatuses or other devices to generate a computer-implemented procedure. Therefore, the instructions executed on the computer, other programmable data processing apparatuses or other devices implement functions/actions stipulated in one or more blocks of the flow chart and/or block diagram.

The flow chart and block diagram in the drawings illustrate system architecture, functions and operations of possible implementations of system, method and computer program product according to multiple implementations of the present disclosure. In this regard, each block in the flow chart or block diagram can represent a module, a part of program segment or code, wherein the module and the part of program segment or code include one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a dedicated hardware-based system for executing stipulated functions or actions, or by a combination of dedicated hardware and computer instructions.

Various embodiments of the present disclosure have been described above and the above description is only exemplary rather than exhaustive and is not limited to the embodiments of the present disclosure. Many modifications and alterations, without deviating from the scope and spirit of the explained various embodiments, are obvious for those skilled in the art. The selection for terms in the text aims to best explain principles and actual applications of each embodiment and technical improvements made in the market by each embodiment, or enable those ordinary skilled in the art to understand embodiments of the present disclosure.

I/We claim:

1. A method for cropping images, comprising:
displaying an image in a plurality of images to be cropped and a set of cropping ratios for the plurality of images;
in response to receiving a selection for a cropping ratio in the set of cropping ratios, displaying the cropped image;
in response to the cropped image being displayed, displaying a control for applying the cropping ratio to the plurality of images on the cropped image; and
in response to receiving an operation for the control, applying the cropping ratio to the plurality of images.

2. The method of claim 1, wherein displaying a control for applying the cropping ratio to the plurality of images on the cropped image comprises:
in response to the cropped image being displayed, generating a control for applying the cropping ratio to the plurality of images;
determining an area available for displaying the control in the cropped image; and
displaying the control in the area of the cropped image.

3. The method of claim 2, wherein displaying a control for applying the cropping ratio to the plurality of images on the cropped image comprises:
displaying a text prompt for applying the cropping ratio to the plurality of images on the control.

4. The method of claim 1, wherein displaying an image in a plurality of images to be cropped and a set of cropping ratios for the plurality of images comprises:
obtaining the plurality of images to be cropped; and
displaying a first image in an image queue formed by the plurality of images.

5. The method of claim 1, further comprising:
in response to the cropping ratio being applied to the plurality of images, stopping display of the control; and
displaying a text prompt that the cropping ratio has been applied to the plurality of images on the cropped image.

6. The method of claim 1, further comprising:
displaying a set of thumbnails corresponding to a set of images in the plurality of images; and
in response the cropping ratio being applied to the plurality of images and a thumbnail in the set of thumbnails being selected, displaying a cropped image corresponding to the thumbnail.

7. The method of claim 1, further comprising:
in response to the control being displayed, determining whether a selection for a predetermined function of the cropped image is received;
in response to receiving a selection for the predetermined function, hiding the control; and
in response to the predetermined function being completed, re-displaying the control.

8. The method of claim 7, wherein the predetermined function comprises at least one of: drag and cropping, mirror, rotation and angle adjustment.

9. The method of claim 8, wherein the predetermined function is angle adjustment and hiding the control in response to receiving a selection for the predetermined function comprises:
in response to receiving a selection for the angle adjustment, hiding the control and the set of cropping ratios; and
in response to the predetermined function being completed, re-displaying the control comprises:
in response to the angle adjustment being completed, re-displaying the control and the cropping ratio.

10. The method of claim 1, wherein the cropping ratio is a first cropping ratio, the image is a first image, and the operation is a first operation, and the method also comprises:
determining that a second image in the plurality of images to which the first cropping ratio is applied is selected;
applying a second cropping ratio in the set of cropping ratios to the second image;
displaying the control for applying the second cropping ratio to the plurality of images on the second cropped image; and
in response to receiving a second operation for the control, applying the second cropping ratio to the plurality of images.

11. The method of claim 10, wherein the method also comprises:
in response to not receiving the second operation for the control, receiving an operation for saving the plurality of images; and
in response to receiving an operation for saving the plurality of images, saving the second cropped image corresponding to the second cropping ratio and the first cropped image corresponding to the first cropping ratio.

12. An electronic device, comprising:
at least one processor; and
a memory for storing at least one program, the at least one program, when executed by the at least one processor, causes the at least one processor to:
display an image in a plurality of images to be cropped and a set of cropping ratios for the plurality of images;
in response to receiving a selection for a cropping ratio in the set of cropping ratios, display the cropped image;
in response to the cropped image being displayed, display a control for applying the cropping ratio to the plurality of images on the cropped image; and
in response to receiving an operation for the control, apply the cropping ratio to the plurality of images.

13. The electronic device of claim 12, wherein the at least one program causing the at least one processor to display a control for applying the cropping ratio to the plurality of images on the cropped image comprises instructions to:
in response to the cropped image being displayed, generate a control for applying the cropping ratio to the plurality of images;
determine an area available for displaying the control in the cropped image; and
display the control in the area of the cropped image.

14. The electronic device of claim 13, wherein the at least one program causing the at least one processor to display a control for applying the cropping ratio to the plurality of images on the cropped image comprises instructions to:
display a text prompt for applying the cropping ratio to the plurality of images on the control.

15. The electronic device of claim 12, wherein the at least one program causing the at least one processor to display an image in a plurality of images to be cropped and a set of cropping ratios for the plurality of images comprises instructions to:
obtain the plurality of images to be cropped; and
display a first image in an image queue formed by the plurality of images.

16. The electronic device of claim 12, wherein the at least one program further causes the at least one processor to:
in response to the cropping ratio being applied to the plurality of images, stop display of the control; and
display a text prompt that the cropping ratio has been applied to the plurality of images on the cropped image.

17. The electronic device of claim 12, wherein the at least one program further causes the at least one processor to:
display a set of thumbnails corresponding to a set of images in the plurality of images; and
in response the cropping ratio being applied to the plurality of images and a thumbnail in the set of thumbnails being selected, display a cropped image corresponding to the thumbnail.

18. The electronic device of claim 12, wherein the at least one program further causes the at least one processor to:
in response to the control being displayed, determine whether a selection for a predetermined function of the cropped image is received;
in response to receiving a selection for the predetermined function, hide the control; and
in response to the predetermined function being completed, re-display the control.

19. The electronic device of claim 18, wherein the predetermined function includes at least one of: drag and cropping, mirror, rotation and angle adjustment.

20. A computer-readable non-transitory storage medium, stored with computer programs thereon, the computer programs, when executed by a processor, cause the processor to:
display an image in a plurality of images to be cropped and a set of cropping ratios for the plurality of images;
in response to receiving a selection for a cropping ratio in the set of cropping ratios, display the cropped image;
in response to the cropped image being displayed, display a control for applying the cropping ratio to the plurality of images on the cropped image; and
in response to receiving an operation for the control, apply the cropping ratio to the plurality of images.
